(19) United States
(12) Patent Application Publication
(10) Pub. No.: US 2006/0292421 A1
(43) Pub. Date: Dec. 28, 2006

(54) Fuel cell device

(75) Inventor: Tomohiro Hirayama, Oume-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/368,985

(22) Filed: Mar. 6, 2006

(30) Foreign Application Priority Data
Jun. 22, 2005 (JP) P2005-181488

(51) Int. Cl. H01M 8/04

(52) U.S. Cl. 429/34

(57) ABSTRACT

A fuel cell device includes: a mixing tank in which a fuel is mixed with a fluid to produce a diluted fuel; a fuel cell that generates electricity by use of the diluted fuel; a flow path through which the diluted fuel is circulated between the fuel cell and the mixing tank; and a filter member that is disposed in the mixing tank and removes metal ions.

### CROSS-REFERENCE TO RELATED APPLICATIONS

This application is based upon and claims the benefit of priority from Japanese Patent Application No. 2005-181488, filed on Jun. 22, 2005, the entire contents of which are incorporated herein by reference.

### BACKGROUND

1. Field

One embodiment relates to a fuel cell device in which generates electricity with using a diluted fuel that is a mixture of a fuel and a fluid, and in which part of a by-product produced in the generation of electricity can be reused as the fluid.

2. Description of the Related Art

Various types of fuel cells have been proposed. As a device suitable for use in a portable computer, a direct methanol fuel cell device (DMFC) is known. An example of a DMFC is disclosed in JP-A-2005-011691).

The conventional DMFC includes a fuel cell, a mixing tank, a fuel tank, an impurity removing device, and flow paths connecting these component to one another. The impurity removing device is placed in the middle of a flow path through which a fuel is supplied from the mixing tank to the fuel cell. Although the details of the impurity removing device are not clear, the device seems to have a case, a filter member such as an ion exchanger housed in the case, and coupling members with the flow paths.

In the mixing tank, the fuel supplied from the fuel tank is mixed with a fluid to produce a diluted fuel. The fuel cell which is supplied with the diluted fuel generates electricity, and discharges a fuel produced in the generation into the mixing tank. The impurity removing device removes away impurities such as metal ions, and supplies the cleaned diluted fuel to the fuel cell.

In the conventional DMFC, the impurity removing device is placed in the middle of the flow path of the supply system, and hence the coupling members for connecting the impurity removing device to the flow paths, and the case for housing the filter member are required. Consequently, a number of parts required in configuring the conventional DMFC increases.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view of the fuel cell device according to a first embodiment;

FIG. 2 is a perspective view showing a state where a portable computer is connected to the fuel cell device of the first embodiment;

FIG. 3 is a plan view showing the internal structure of the body of the fuel cell device shown in FIG. 1;

FIG. 4 is a block diagram of the fuel cell device of the first embodiment;

FIG. 5 is a section view of a mixing tank of the fuel cell device shown in FIG. 1; and

FIG. 6 is a section view of a mixing tank of a fuel cell device according to a second embodiment.

### DETAILED DESCRIPTION

Various embodiments according to the invention will be described hereinafter with reference to the accompanying drawings.

### First Embodiment

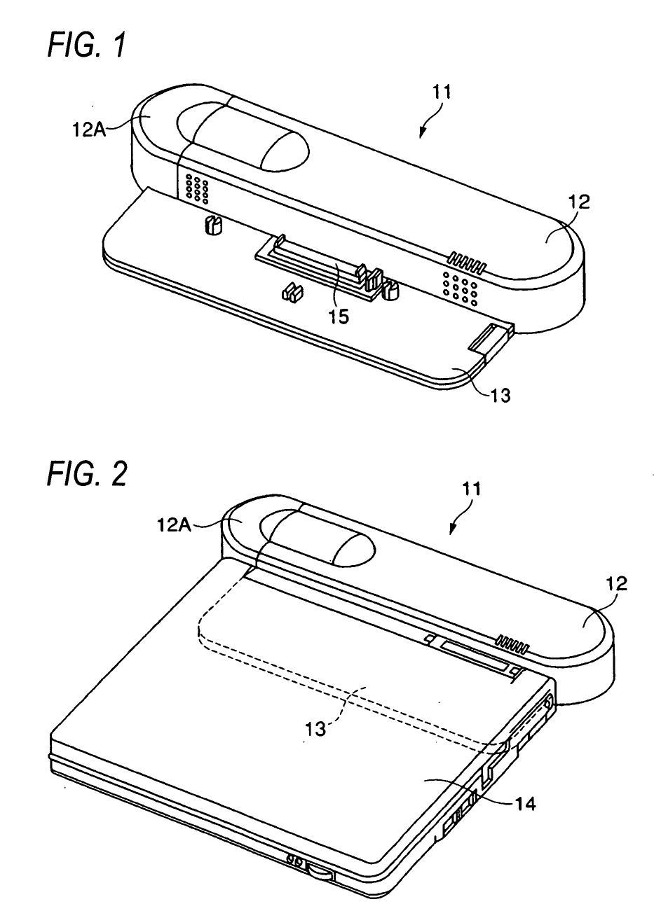

Hereinafter, with reference to FIGS. 1 to 5, a fuel cell device according to a first embodiment will be described with exemplifying the case where the device is applied to a portable computer.

FIG. 1 is a perspective view showing the appearance of the fuel cell device 11. The fuel cell device 11 is a direct methanol fuel cell device (DMFC) that uses methanol as a liquid fuel, and in which a dilution circulation system circulating methanol is employed. In the dilution circulation system, high-concentration methanol is diluted to produce a low-concentration methanol aqueous solution which is an example of a diluted liquid fuel, and generation of electricity is performed with using the methanol aqueous solution.

The fuel cell device 11 includes a device body 12, and a stand portion 13 that is extended from the device body 12. As shown in FIG. 2, the stand portion 13 is formed so as to support a rear portion of an electronic apparatus such as a portable computer 14. A power source connector 15 which is to be connected to the portable computer 14 is disposed on the upper face of the stand portion 13. The fuel cell device 11 is configured to be detachably connected to the portable computer 14.

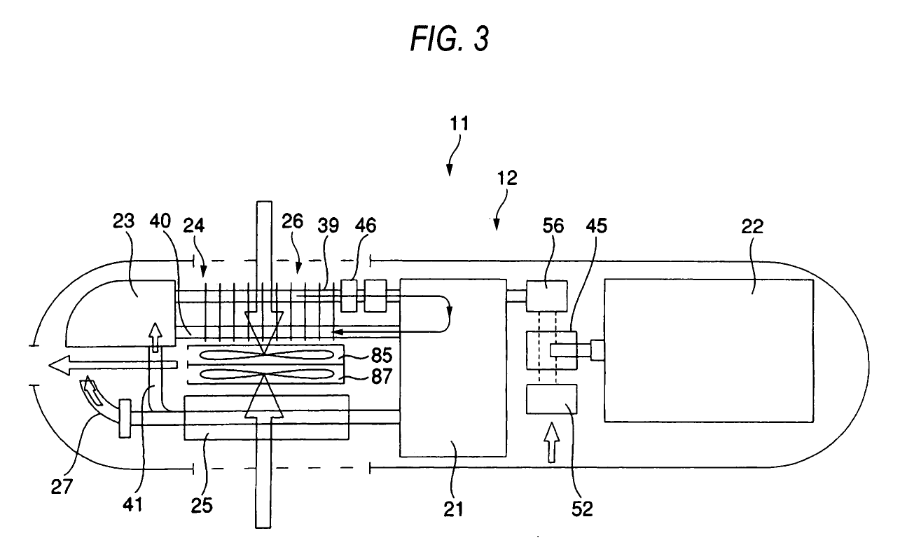

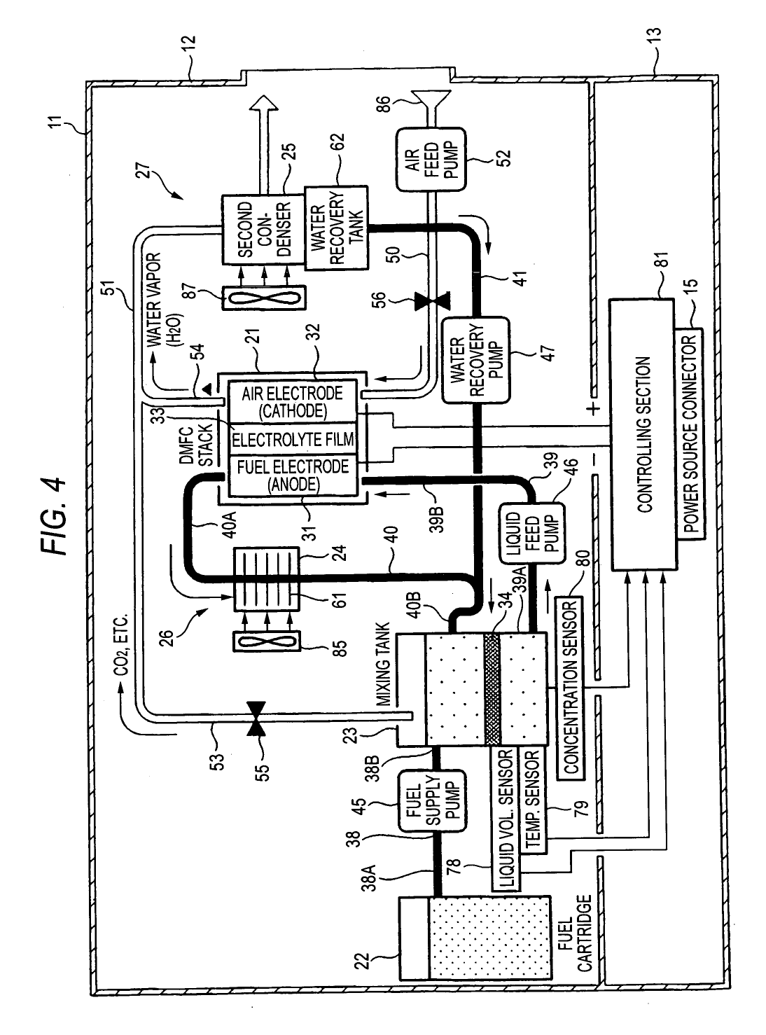

As shown FIGS. 3 and 4, the device body 12 includes a DMFC stack 21 serving as a fuel cell, a fuel cartridge 22, a mixing tank 23, a first condenser 24, a second condenser 25, a liquid flow path 26 connecting the components together, and a gas passage 27. The DMFC stack 21 has a fuel electrode 31 (anode) , an air electrode 32 (cathode), and an electrolyte film 33 which is interposed between the electrodes 31, 32.

The fuel cartridge 22 stores high-concentration methanol. As shown in FIG. 3, the fuel cartridge 22 is fixed to one end of the device body 12, and, as shown FIG. 1, covered by a cover 12A. When the cover 12A is detached, therefore, the fuel cartridge 22 can be replaced with a new one.

In the mixing tank 23, high-concentration methanol supplied from the fuel cartridge 22 is mixed with water supplied from the air electrode 32 of the DMFC stack 21 to produce a methanol aqueous solution having a concentration of about several to several tens percent. A filter member 34 which removes metal ions from the methanol aqueous solution is disposed in the mixing tank 23.

The liquid flow path 26 is configured by a fuel flow path 38, a diluted fuel flow path 39, a recovery flow path 40, and a discharge flowpath 41. The fuel flowpath 38 is connected in an upstream end portion 38A to the fuel cartridge 22, and in a downstream end portion 38B to the mixing tank 23. The high-concentration methanol is supplied from the fuel cartridge 22 to the mixing tank 23 via the fuel flow path 38. The diluted fuel flow path 39 is connected in an upstream connecting portion 39A to the mixing tank 23, and in a downstream connecting portion 39B to a supply end of the fuel electrode 31 of the DMFC stack 21. The methanol aqueous solution produced in the mixing tank 23 is supplied to the fuel electrode 31 of the DMFC stack 21 via the diluted fuel flow path 39.

The recovery flow path 40 is connected in an upstream communicating portion 40A to a discharge side of the fuel electrode 31, and in a downstream communicating portion 40B to the mixing tank 23. The methanol aqueous solution which is not used in the generation by the fuel electrode 31 is returned to the mixing tank 23 via the recovery flow path 40. The discharge flow path 41 is connected in an upstream side to the second condenser 25, and joined in a downstream side to the downstream communicating portion 40B of the recovery flow path 40. Water which is stored in a water recovery tank 62 of the second condenser 25 is returned to the mixing tank 23 via the discharge flow path 41. The diluted fuel flow path 39 and the recovery flow path 40 constitute the flow path in the invention.

A fuel supply pump 45 which pressure-feeds the high-concentration methanol to the mixing tank 23 is disposed in the middle of the fuel flow path 38. A liquid feed pump 46 which feeds the methanol aqueous solution to the fuel electrode 31 is disposed in the middle of the discharge flow path 41. A water recovery pump 47 which pressure-feeds water to the mixing tank 23 is disposed in the middle of the discharge flow path 41.

The gas passage 27 has an air supply passage 50 and an exhaust passage 51. The air supply passage 50 is connected to the air electrode 32 of the DMFC stack 21. An air feed pump 52 which feeds the air to be used in the generation to the air electrode 32 is disposed in an upstream portion of the air supply passage 50.

The exhaust passage 51 has: a first portion 53 that is connected to the mixing tank 23 to exhaust a gas in the mixing tank 23; and a second portion 54 which is connected to the air electrode 32 of the DMFC stack 21 to exhaust water vapor discharged from the air electrode 32. Valves 55, 56 are disposed in the middles of the air supply passage 50 and the exhaust passage 51, respectively.

The first condenser 24 is disposed in the middle of the recovery flow path 40. The first condenser 24 cools the methanol aqueous solution which is returned from the fuel electrode 31 to the mixing tank 23, and has plural radiation fins 61. The second condenser 25 is disposed in a portion of the exhaust passage 51 that is positioned downstream from the joining portion of the first portion 53 and the second portion 54. The second condenser 25 liquefies a fluid such as water vapor exhausted from the air electrode 32, and the liquefied fluid is recovered to the water recovery tank 62.

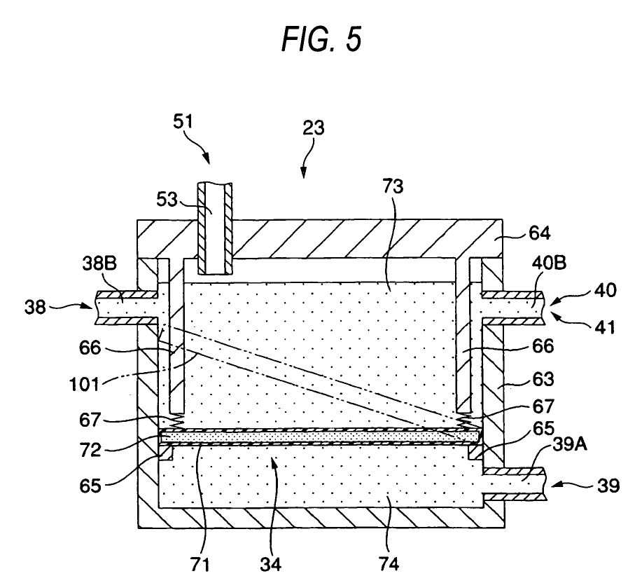

As shown in FIG. 5, the mixing tank 23 includes a tank body 63 which is a storage tank for the methanol aqueous solution, and a cover member 64 which closes the tank body 63. The upstream end of the first portion 53 of the exhaust passage 51 is fixed to the cover member 64 so as to be opened in the tank. A pair of support projections 65, 65 for supporting the filter member 34 are disposed on the inner face of the tank body 63. The filter member 34 is horizontally stretched between the upper faces of the support projections 65. The cover member 5 64 has a pair of pressing members 66, 66 for pressing the filter member 34. Each of the pressing members 66 has a spring member 67 at its tip end. The spring members 67 press the filter member 34 against the support projections 65. Therefore, the filter member 34 is held between the support projections 65, 65 arid 10 the pressing members 66, 66, and horizontally placed in the tank body 63.

The filter member 34 is configured by a flat case 71 in which a plurality of small holes are formed in the surface, and a plurality of ion-exchange resins 72 which are charged in 1 5 the case 71. The case 71 is made of a synthetic resin, and has a predetermined strength. Each of the ion-exchange resins 72 is formed into a granular shape.

The filter member 34 partitions the interior of the tank body 63 into a first compartment 73 and a second compartment 20 74. The first compartment 73 is positioned above the filter member 34. The downstream end portion 38B of the fuel flow path 38, and the downstream communicating portion 40B of the recovery flow path 40 are connected to the tank body 63 so as to be opened in the first compartment 73. 25

The second compartment 74 is positioned below the filter member 34. The upstream connecting portion 139A of the diluted fuel flow path 39 is connected to the tank body 63 so as to be opened in the second compartment 74.

Therefore, the methanol aqueous solution is not moved into the second compartment 74 unless it is passed through the filter member 34.

The filter member 34 is positioned below the level of the methanol aqueous solution which is stored in the tank body 63, and always immersed in the methanol aqueous solution.

As shown in FIG. 4, the mixing tank 23 includes: a liquid volume sensor 78 that detects the quantity of the methanol aqueous solution in the tank; a temperature sensor 79 that detects the temperature of the methanol aqueous solution; and a concentration sensor 80 that detects the concentration of the methanol aqueous solution. Data which are detected by the sensors 78, 79, 80, and which relate to the methanol aqueous solution are sent to a controlling section 81. Based on the data from the sensors 78, 79, 80, the controlling section 81 controls the fuel supply pump 45, the water recovery pump 47, and the like. According to the configuration, the quantity of the high-concentration methanol that flows from the fuel cartridge 22 into the mixing tank 23, and that of water which flows from the water recovery tank 62 into the mixing tank 23 are adjusted so that the concentration of the methanol aqueous solution is controlled to a value by which the performance of electricity generation is satisfactorily maintained.

Next, the electricity generating operation of the fuel cell device 11 will be described.

The high-concentration methanol in the fuel cartridge 22 is fed by the fuel supply pump 45 to the first compartment 73 in the mixing tank 23. Water which is recovered from water vapor or the like that is a fluid discharged from the air electrode 32 of the DMFC stack 21, and the low-concentration methanol which is a fluid discharged from the fuel electrode 31 of the DMFC stack 21 are fed to the first compartment 73 in the mixing tank 23. Therefore, the high-concentration methanol is mixed with the water and the low-concentration methanol, and a methanol aqueous solution having a predetermined concentration is produced in the mixing tank 23.

The produced methanol aqueous solution moves from the first compartment 73 to the second compartment 74 which is below the first compartment. At this time, metal ions contained in the methanol aqueous solution are adsorbed by the ion-exchange resins 72 of the filter member 34 to be removed from the methanol aqueous solution. Therefore, the methanol aqueous solution in the second compartment 74 does not contain metal ions.

The methanol aqueous solution from which metal ions are removed is pressure-fed by the liquid feed pump 46 toward the fuel electrode 31 of the DMFC stack 21. In the fuel electrode 31, methanol reacts with water to be oxidized, and electrons are generated. As a result of the oxidization reaction, hydrogen ions and carbon dioxide are produced as products. The produced hydrogen ions pass through the electrolyte film 33 in the DMFC stack 21, and reach the air electrode 32.

The carbon dioxide which is produced in the fuel electrode 31 is led together with unreacted methanol aqueous solution to the first condenser 24, cooled by a first fan 85, and then returned to the mixing tank 23 via the recovery flow path 40. The carbon dioxide which is returned to the mixing tank 23 vaporizes in the mixing tank 23, and is discharged to the outside via the exhaust passage 51.

On the other hand, the air to be used in the generation of electricity is taken in through an air intake port 86, and pressurized by the air feed pump 52 to be fed to the air electrode 32 of the DMFC stack 21. In the air electrode 32, oxygen in the air is coupled with the hydrogen ions and electrons to be reduced, and water vapor is produced as a product. At this time, electrons flow through an external circuit connected to the fuel electrode 31 and the air electrode 32, whereby the electricity generating operation is conducted.

Among the products produced in the electricity generation process, the water vapor produced in the air electrode 32 is led to the second condenser 25 via the second portion 54 of the exhaust passage 51. In the second condenser 25, the water vapor is cooled by a second fan 87 to become water. The water is temporarily stored in the water recovery tank 62, and then returned to the mixing tank 23 via the discharge flow path 41 to be reused as a fresh fluid in the production of a methanol aqueous solution.

The first embodiment of the fuel cell device 11 is configured as described above. According to the first embodiment, coupling members for connecting the filter member 34 to the flow path, a case for covering the filter member 34 are not required. Therefore, the number of parts and the installation space can be reduced.

In the mixing tank 23, the methanol aqueous solution is in the state of rest. Therefore, a phenomenon that the metal ions are flown to the fuel electrode 31 by a flow of the methanol aqueous solution does not occur, and hence the metal ions can be surely removed. Since the interior of the mixing tank 23 is partitioned into the first compartment 73 and the second compartment 74, it is possible to prevent the methanol aqueous solution from which metal ions are removed from being mixed with that from which metal ions are not removed.

At startup of the fuel cell device 11, the methanol aqueous solution from which metal ions are previously removed by the filter member 34 is supplied to the DMFC stack 21. Therefore, methanol aqueous solution which contains metal ions does not flow into the DMFC stack 21, whereby reduction of the generation efficiency due to metal ions is prevented from occurring. Moreover, the filter member 34 is disposed in the mixing tank 23 which is a relatively large structural member in the device, and hence the filter member 34 can be easily replaced with a new one in a state where the cover member 64 is detached.

### Second Embodiment

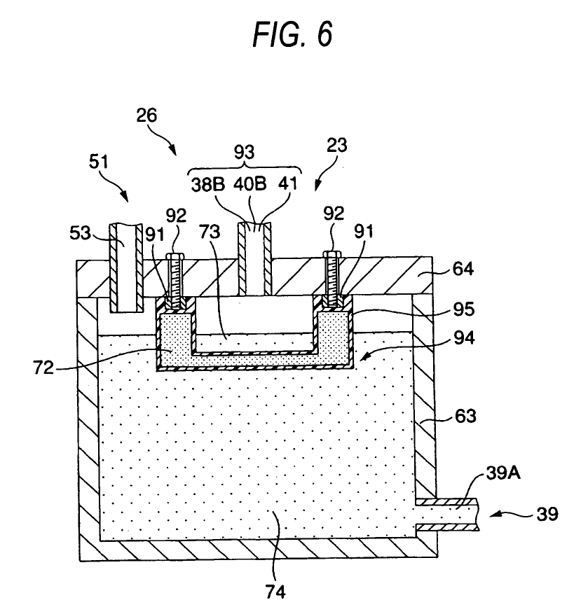

Next, a fuel cell device 11 according to a second embodiment will be described with reference to FIG. 6. The fuel cell device 11 according to the second embodiment is configured in the same manner as the first embodiment except the mixing tank 23, a filter member 94, and the liquid flow path 26. Therefore, the identical components are denoted by the common reference numerals, and their description is omitted.

In the second embodiment, the filter member 94 is detachably attached to the cover member 64 of the mixing tank 23. The filter member 94 has a case 95. The case 95 is formed into a cylindrical shape by, for example, a synthetic resin. A plurality of nuts 91 are embedded in an upper end portion of the case 95. The filter member 94 is fixed to the cover member 64 by inserting bolts 92 into the nuts 91. A plurality of small holes are formed in the surface of the case 95. A plurality of plural granular ion-exchange resins 72 which are similar to those in the first embodiment are charged in the case 95.

The downstream end portion 38B of the fuel flow path 38, the downstream communicating portion 40B of the recovery flow path 40, and the downstream side of the discharge flow path 41 are joined together immediately before the mixing tank 23 to constitute a joint connecting portion 93. The joint connecting portion 93 is connected to the cover member 64 so as to guide the liquids which are supplied to the mixing tank 23 from the flow paths 38, 40, 41 are guided from the upper side of the filter member 94 to the interior of the tank. The filter member 94 partitions the interior of the mixing tank 23 into the first compartment 73 and the second compartment 74, and is immersed in the methanol aqueous solution.

In the second embodiment, since the filter member 94 is detachably attached to the cover member 64, the filter member 94 can be easily replaced with a new one. As required, the filter member 94 can be replaced together with the cover member 64.

### Third Embodiment

Next, a fuel cell device 11 according to a third embodiment will be described with reference to FIG. 5. The third embodiment is different from the first embodiment in placement of a filter member 101. Therefore, the placement of the filter member 101 will be described, the other components are denoted by the common reference numerals, and their description is omitted.

In the third embodiment, the filter member 101 indicated by the two-dot chain line is disposed to be inclined in the mixing tank 23. In the third embodiment also, the filter member 101 partitions the interior of the mixing tank 23 into the first compartment 73 and the second compartment 74, and is immersed in the methanol aqueous solution.

According to the third embodiment, the area in which the filter member 101 is in contact with the methanol aqueous solution can be increased. Therefore, the adsorption rate of metal ions can be improved. The degree of the inclination of the filter member 101 is not restricted to the embodiment. The filter member 101 can be placed anyway as far as the interior of the mixing tank 23 can be partitioned into the first compartment 73 and the second compartment 74.

As described above in detail with respect to the embodiments, the fuel cell device requires no dedicated case for housing the filter member, and no special coupling members for connecting the filtering member to flow paths. Therefore, the number of parts for configuring the fuel cell device can be reduced.

The application of the fuel cell device of the invention is not limited to a portable computer shown in the embodiments. The fuel cell device may be applied as a power source for another electronic apparatus such as a PDA (personal digital assistant) device.

It is to be understood that the present invention is not limited to the specific embodiments described above and that the present invention can be embodied with the components modified without departing from the spirit and scope of the invention. The present invention can be embodied in various forms according to appropriate combinations of the components disclosed in the embodiments described above. For example, some components may be deleted from all components shown in the embodiment. Further, the components in different embodiments may be used appropriately in combination.

What is claimed is:

1. A fuel cell device comprising:
a mixing tank in which a fuel is mixed with a fluid to produce a diluted fuel;
a fuel cell that generates electricity by use of the diluted fuel;
a flow path through which the diluted fuel is circulated between the fuel cell and the mixing tank; and
a filter member that is disposed in the mixing tank and removes metal ions.

2. The fuel cell device according to claim 1, wherein the flow path comprises:
a diluted fuel flow path through which the diluted fuel is supplied from the mixing tank to the fuel cell; and
a recovery flow path through which the diluted fuel that is unused in the generation of electricity is returned from the fuel cell to the mixing tank, and
wherein the filter member partitions an interior of the mixing tank into:
a first compartment into which the diluted fuel that is returned from the fuel cell flows; and
a second compartment into which the diluted fuel from which the metal ions are removed by the filter member flows.

3. The fuel cell device according to claim 1, wherein the mixing tank comprises:
a tank body; and
a cover member that closes the tank body, and
wherein the filter member is detachably attached to the cover member.

4. The fuel cell device according to claim 1, wherein the filter member is immersed in the diluted fuel in the mixing tank.

5. An electronic apparatus comprising:
a body; and
a fuel cell device detachably connected to the body,
wherein the fuel cell device comprising:
a mixing tank in which a fuel is mixed with a fluid to produce a diluted fuel;
a fuel cell that generates electricity by use of the diluted fuel;
a flow path through which the diluted fuel is circulated between the fuel cell and the mixing tank; and
a filter member that is disposed in the mixing tank and removes metal ions.

6. The electronic apparatus according to claim 5, wherein the flow path comprises:
a diluted fuel flow path through which the diluted fuel is supplied from the mixing tank to the fuel cell; and
a recovery flow path through which the diluted fuel that is unused in the generation of electricity is returned from the fuel cell to the mixing tank, and
wherein the filter member partitions an interior of the mixing tank into:
a first compartment into which the diluted fuel that is returned from the fuel cell flows; and
a second compartment into which the diluted fuel from which the metal ions are removed by the filter member flows.

7. The electronic apparatus according to claim 5, wherein the mixing tank comprises:
a tank body; and
a cover member that closes the tank body, and
wherein the filter member is detachably attached to the cover member.

8. The electronic apparatus according to claim 5, wherein the filter member is immersed in the diluted fuel in the mixing tank.
